(19) United States
(12) Patent Application Publication
(10) Pub. No.: US 2011/0050426 A1
(43) Pub. Date: Mar. 3, 2011

(54) RFID label readable on surfaces which interferes with RF waves and method of manufacturing the same

(76) Inventor: Alex Poh Teck Choong, Singapore (SG)

(21) Appl. No.: 12/800,317

(22) Filed: May 13, 2010

(30) Foreign Application Priority Data
Aug. 27, 2009 (SG) 200905709-2

(51) Int. Cl. G08B 13/14

(52) U.S. Cl. 340/572.1

(57) ABSTRACT

A RFID tag (10) for affixing onto surfaces which interfere with RF waves is formed from folding the said RFID label (12) which has been encoded and printed, into two or more folds to form a standoff of two or more folds high.

The said RFID tag (10) when affixed onto the surface which interfere with RF waves can be read with a RF scanner.

A method and system for making and folding the said RFID label (12) is also disclosed.

### TECHNICAL FIELD

The present invention is related to a RFID label which can be attached to surfaces which interferes with the reading of RFID labels and a method of manufacturing the same.

### BACKGROUND ART

Radio Frequency Identification (RFID) uses a smart tag capable of transmitting data by radio. The basic RFID system consists of 3 components:—
An antenna or coil
A transceiver (with decoder)
A transponder tag (called a RFID tag) electronically programmed with unique information

The basic feature of a RFID tag is to detect the interrogation field or transmission in order to affect a response for data transfer. The main components in a RFID tag circuitry essentially comprises of the following elements:—
The antenna and radio frequency receiver and transmission circuit
Micro-processing circuit for control and data management purpose.
Memory, appropriate to data carrier and functionality needs.

There are basically 3 types of RFID transponders that are most widely used in the world. They are (a) contactless cards, (b) contactless tickets and (c) smart labels.

A smart RFID label has a transponder device with a programmable microchip and an antenna. Data can be read or written with a reader device, without a direct line of sight. Transponders embedded inside paper labels (“RFID labels”) assist businesses in product identification, control, tracking and security and are used in a wide variety of applications including:
Airline baggage management
Library systems and rental services
Retail, including electronic article surveillance
Supply chain logistics
Postal and parcel tracking services
Personnel identification and ticketing
Waste management
Vehicle identification
Fraud control and identification

A RFID tag communicates with a scanner by radio frequency (RF) waves. However, it is very difficult to read a RFID tag when it is affixed on surfaces which interfere with the RF waves, such as metallic surfaces or curved surfaces or when the surface is reflective. The problem is that the metallic and other surfaces on which the RFID labels are affixed to, such as bottles, plastic bags, containers containing fluids causes interference with the RF waves, thereby causing reading of the RFID tag difficult if not impossible. The obvious implication is that metallic and other surfaces on which the RFID labels are affixed to, such as bottles, plastic bags, containers containing fluids, prevent data from returning from a RFID tag. Unfortunately, few RFID-appropriate applications exist in which metallic surface and other surfaces which caused interference to RF waves are not present.

In the case of metallic and other surfaces on which the RFID labels are affixed to, reflection is a double-edged sword. Reflection can be extremely beneficial, allowing RF waves to bounce around materials that would otherwise block their reception. However, reflected waves can also be a source of interference that can decrease read ranges and tag performance. Compounding this is the fact that such surfaces takes many forms; foil bags may be obvious, but rice, with its high iron content, is not.

Metallic and other surfaces which interfere with RF waves cause problems for standard RFID antennas-devices affixed to metallic and other surfaces. The proximity of the metallic and other surfaces to the RFID tag adds an additional reactance to the RFID tag's circuit. It is believed that a shift in the resonant frequency of the antenna, destroys the impedance match between the antenna and the chip, rendering the tags unreadable, even at point-blank range.

Even if the antenna is directly placed on a metallic or other surfaces which interfere with RF waves, their read range is decreased to unacceptable levels. Typically, such tags cannot be read or interrogated. In such cases, it is believed that a propagating-wave RF tag uses an integral antenna to receive the incident radiation: the antenna's dimensions and geometry dictate the frequency at which it resonates, and hence the frequency of operation of the tag. When the tag is placed near or in direct contact with a metallic surface, the tag's conductive antenna interacts with that surface.

There have been several approaches to solve the problem of reading a RFID tag on surfaces which causes interference to RF waves.

GB 2429878 (C. R. Lawrence et al) describes an invention for a multi-layer structure that acts as a radiation decoupling device in the wavelength range of λₘᵢₙ to λₘₐₓ. The decoupler has a first conductor layer in contact with a dielectric layer which comprises at least one are of absence and the thickness of the decoupler is less than λₘᵢₙ/4n, where n is the refractive index of the dielectric. The dielectric layer may be sandwiched between the two conductor layers. The conductive layer may comprise two or more islands separated by an aperture of sub-wavelength dimension. A RF tag is positioned over the area of absence or aperture and is decoupled from the detrimental effects of metal surfaces to which the tag is attached.

US 20080024273 (Kruest; James Robert; et al.) proposes a method wherein stirring of the generated electromagnetic field moves around the regions of low energy, where tags cannot be read, during the interrogation process. Mechanical stirring is accomplished by introducing a conductor into the electromagnetic field and moving it about in the field. Solid state stirring is accomplished by introducing a variable conductor into the field and varying the conductivity of the variable conductor. Mathematical stirring is accomplished by use of a plurality of antenna and controlling the phase difference between the antenna in a configuration known as phased antenna arrays.

Traditionally, microstrip antennas are viewed as unbalanced devices, having a signal (feed) and ground (ground plane). The IC is a two-terminal device with a characteristic impedance. The IC can be integrated into two antenna terminals of a balanced device, such as a dipole, or one terminal may accept a signal and the other grounded, which is the case with practically all microstrip designs. Since the signal is one plane and ground is on another, microstrip RFID tag designs traditionally require some way of crossing planes, such as a via, which makes them relatively difficult and expensive to manufacture. Kansas University have developed a simple balanced feed approach. Like a traditional edge-feed microstrip designs, a microstrip transmission line is attached at the desired impedance point. However, two feeds are proposed. Since the microstrip antenna is a half wavelength, and there is a line of odd mode symmetry through the middle of the antenna, the two feeds are then 180 degrees out of phase, i.e., they form a balanced feed.

The solutions offered by the prior art are costly and tends to drive the costs of RFID tags upwards, making the use of RFID tags uneconomical. What is required is a simple yet less costly alternative to enable the RFID tags to be read even when the RFID tags are affixed onto metallic and other surfaces which interfere with the RF waves.

### SUMMARY OF THE INVENTION

A first object of the present invention is a low cost RFID tag for affixing onto surfaces which interfere with RF waves, said RFID tag formed from a RFID label, said RFID label comprising of a RFID tag embedded in a layer of material, an upper adhesive layer on the upper protective layer and a lower adhesive layer on the lower protective layer, the said RFID label being encoded, printed and folded into two or more folds and then compressed to force air trapped between the folds to form a standoff of two or more folds high so that the RFID tag can be read when it is affixed onto the surface which interfere with RF waves.

A second object is a RFID tag for affixing onto surfaces which interfere with RF waves is formed from a RFID label, said RFID label comprising of a RFID tag embedded in a layer of material, an upper adhesive layer on the upper protective layer and a lower adhesive layer on the lower protective layer, the said RFID label being encoded, printed and an anti-tampering perforation made across the length of the RFID label such that the anti-tampering perforation runs right up to the RFID tag, said RFID label further folded into two or more folds to form a standoff of two or more folds so that the RFID tag can be read when it is affixed onto the surface which interfere with RF waves.

Preferably, the RFID tag is affixed to surfaces which interfere with RF waves, such surfaces being metallic surfaces.

Preferably, the RFID tag is affixed to surfaces which interfere with RF waves, such surfaces being curved surfaces.

Preferably, the RFID tag is affixed to surfaces which interfere with RF waves, such surfaces being glass surfaces.

Preferably, the RFID tag is affixed to surfaces which interfere with RF waves, such surfaces being bottles containing fluids.

Preferably, the RFID tag is affixed to surfaces which interfere with RF waves, such surfaces being surfaces covered with reflective metallic foil.

Preferably, the layer of material used in the RFID label is made of plastic.

Preferably, the layer of material used in the RFID label is made of cloth.

Preferably, the layer of material used in the RFID label is made of paper.

Preferably, the layer of material used in the RFID label is a composition of laminates.

Preferably, the adhesive layer on the lower protective layer is at both ends of the RFID label.

More advantageously, the RFID label has an adhesive layer on the lower protective layer which is throughout the lower protective layer.

Preferably, the RFID label has markings indicated on it for alignment of the RFID label and to aid in the folding process.

A third object of the invention is a method for making a RFID label, the method consisting of the following steps:—
a. using a feeder to feed a roll of RFID labels into a printer for encoding and printing of data onto the RFID tag in the RFID label;
b. encoding and printing data onto the RFID tag and RFID label;
c. folding the RFID label thus printed and encoded, into two or more folds to form a standoff; and
d. subjecting the folded RFID label to compression forces, to force air trapped between the folds of the RFID label to escape;

Alternatively, the step of folding and compressing the RFID label is carried out manually.

A fourth object of the invention is a system for encoding, printing and folding a RFID label into a plurality of folds, to form a standoff which height is equal to the number of folds formed, the system comprising:—
a. a printer for printing data onto a RFID label onto the RFID label;
b. an encoder for encoding data onto the RFID tag embedded in a RFID label;
c. a folding device to fold the RFID label lengthwise, in accordance to the number of folds required to form a standoff,

More advantageously, the system for encoding, printing and folding a RFID label into a plurality of folds, to form a standoff which height is equal to the number of folds formed, further comprises
a. a perforator which makes a line of anti tampering perforations along the length of the RFID label, right until the location of the RFID tag embedded in the RFID label;

Preferably, the system for encoding, printing and folding a RFID label has a plurality of sensors to detect the markings o the RFID label, in order to align the RFID label and to fold the RFID label in accordance with the number of folds required.

### BRIEF DESCRIPTION OF THE DRAWINGS

For a better understanding of the invention, its advantages, and the objects attained by its use, reference should now be made to the accompanying drawings. The accompanying drawings illustrate one or more embodiments of the invention and together with the description herein, serve to explain the workings and principles of the invention.

FIG. 1 is a cross section of a RFID label of the prior art affixed onto an article with a metallic or surface which interfere with RF waves.

FIG. 1A is a cross section of a RFID label of the prior art affixed onto an article with a metallic or surface which interfere with RF waves and the interference caused to the signals send out by a transponder.

FIG. 2 is a perspective view of a roll of RFID labels of the invention. FIG. 2A is an enlarged view of a cross section of a RFID label of the invention.

FIG. 3 is a top view of a RFID label of the invention.

FIG. 3A is a top view of the RFID tag which is embedded in the RFID label.

FIG. 4 is a top view of a RFID label of the invention wherein the RFID tag is placed in a different position.

FIG. 4A is a top view of the RFID tag which is embedded in the RFID label.

FIG. 5 is a perspective view of a RFID label of the invention, said RFID label being enfolded lengthwise.

FIG. 5A is a perspective view of a RFID label of the invention wherein the RFID tag is located in a different position, said RFID label being enfolded lengthwise.

FIG. 6 is a cross section view of a RFID label of the invention, from one end, after enfolding.

FIG. 6A is an enlarged view of a portion of the label shown in FIG. 6.

FIG. 7 is a cross section of a RFID label of the invention, from one end, affixed onto an article with a metallic surface and showing transmission of signals from the transponder and reception of the signals by the RFID label and surroundings.

FIG. 7A is an enlarged view of a portion of the label shown in FIG. 7.

FIG. 8 is an illustration of an embodiment of a system for the encoding, printing and folding into the RFID label to form the RFID tag of the invention.

### BEST MODE FOR CARRYING OUT THE INVENTION

The inventors having studied the problems associated with reading RFID tags (10) affixed onto metallic and other surfaces which interfere with RF waves. They propose a simple yet effective method to make a RFID label (12) capable of being read even when affixed onto such surfaces.

For a better understanding of the invention, its advantages, and the objects attained by its use, reference should now be made to the accompanying drawings. The accompanying drawings illustrate one or more embodiments of the invention and together with the description herein, serve to explain the workings and principles of the invention.

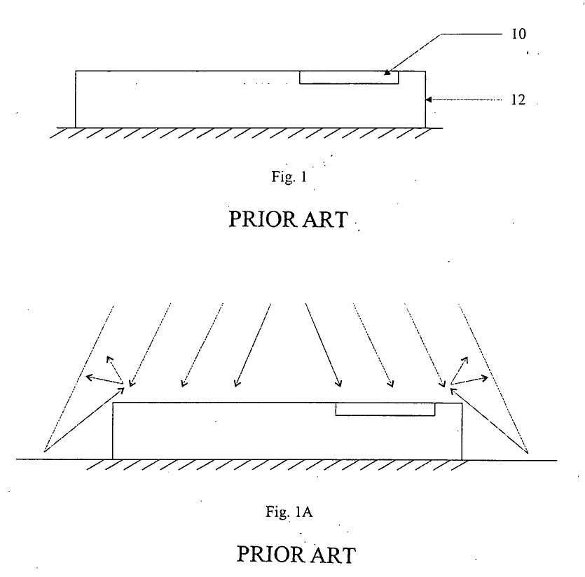

FIG. 1 shows a cross section of a RFID label (12) of the prior art affixed onto an article with a surface which interferes with RF waves. The surface could be metallic or other surfaces on which the RFID labels (12) are affixed to, such as bottles, plastic bags, containers containing fluids causes interference with the RF waves

FIG. 1A is a cross section of a RFID label (12) of the prior art affixed onto an article affixed onto a surface which interferes with RF waves being the signals send out by a transponder. The proximity of the surface to the RFID tag (10) adds an additional reactance to the RFID tag's (10) equivalent circuit. This results in a shift in the resonant frequency of the antenna, destroying the impedance match between the antenna and the chip, rendering the RFID tag (10) unreadable, even at point-blank range.

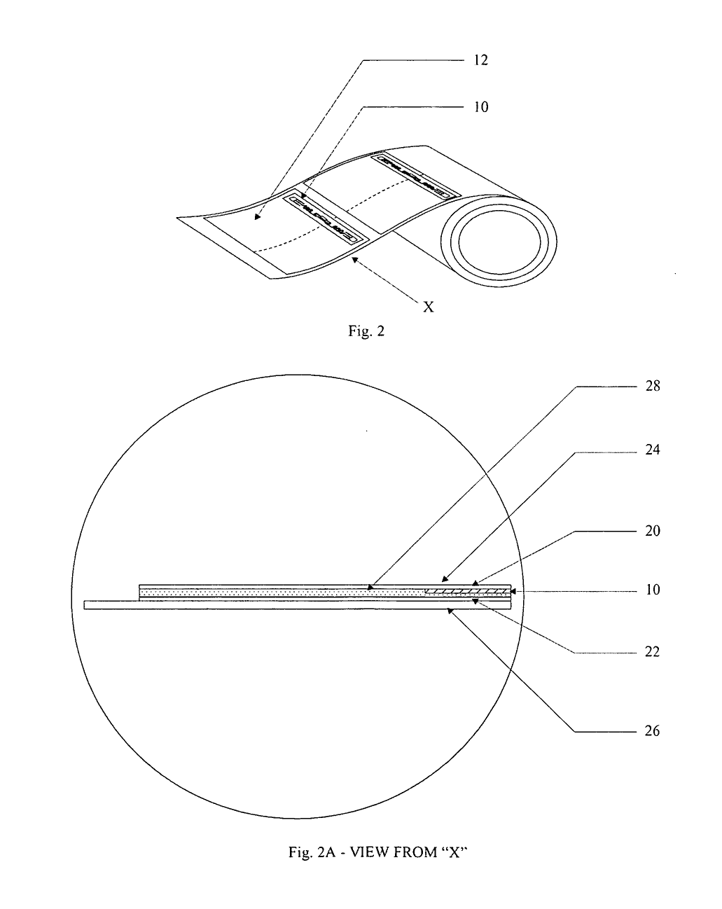

FIG. 2 is a perspective view of a roll of liner with RFID labels (12) of the invention.

FIG. 2A is an enlarged view of a cross section of a RFID label (12) of the invention. The RFID tag (10) is shown embedded within a layer of the material (28) forming the RFID label (12). The RFID label (12) of the invention would also have an upper adhesive layer (20) which is covered with an upper protective layer (24). The layer of material (28) also has a lower adhesive layer (22). Finally the RFID label (12) has a lower protective layer (26). Typically, the RFID tag (10) is laid across the breath of RFID label (12), at the second end of the said RFID label (12). The layer of material (28) used in the RFID label (12) can be paper or any synthetic material, fabric, paper or a combination of materials or composite materials. The choice of the material (28) forming the layer for embedding the RFID tag (10) to form the RFID label (12) depends on the use of the RFID tag (10). If the RFID tags (10) are used for asset tracking in the open, the material (28) selected would be suitably adapted for the harsh climatic conditions expected in an outdoor environment.

A roll of RFID labels (12) can be produced by a system for batch conversion of RFID tags (10) into RFID labels (12) such as the system described in PCT/SG2004/000302 “SYSTEM AND METHOD FOR BATCH CONVERSION OF RFID TAGS INTO RFID LABELS” in the name of the Inventors.

The roll of RFID labels (12) are appropriately dimensioned so that each RFID label (12) can be folded lengthwise into a plurality of two or more layers. The roll of RFID labels (12) are then encoded using RFID printing/coding printers (44a/44b) using software for encoding RFID tags (10) which is known in the art.

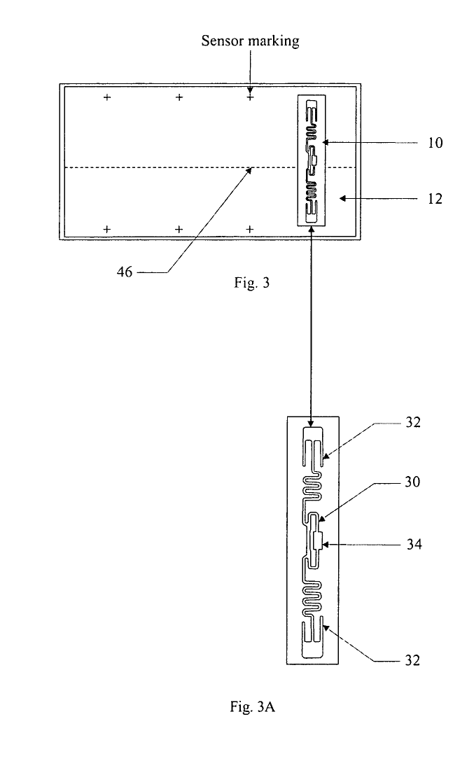

FIG. 3 is a top view of a RFID label (12) of the invention. The RFID tag (10) is shown embedded across the breath of the RFID label (12), near the second end of the said RFID label (12). An anti-tampering perforation (46) runs length-wise along the RFID label (12) said anti-tampering perforation (46) positioned anywhere across the in-built RFID antenna coil (30) in the RFID tag (10). Appropriate markings on the RFID label (12) which serve as folding indicators are printed along the length of the RFID label (12) for alignment purpose and as guides in the folding process.

FIG. 3A is a magnified top view of a RFID label (12) of the invention. The RFID tag (10) consists of 3 components:—
An antenna coil (30)
A dipole at each end (32)
A chip (34) electronically programmed with unique data

The RFID tag (10) thus is a closed circuit. Should the RFID label (12) be torn, the anti-tampering perforations (46) will be subject to tear stress first, thus causing the tearing to run along the anti-tampering perforations (46). Once the anti-tampering perforations (46) is subjected to tear stress, stress forces will run along the anti-tampering perforations (46) right to the RFID tag (10). Should this occur, the closed circuit in the RFID tag (10) will be broken, rendering the RFID tag (10) unreadable. Once a RFID tag (10) is unreadable, and the anti-tampering perforations (46) are broken, it would mean someone had tampered with the article on which the RFID tag (10) has been affixed.

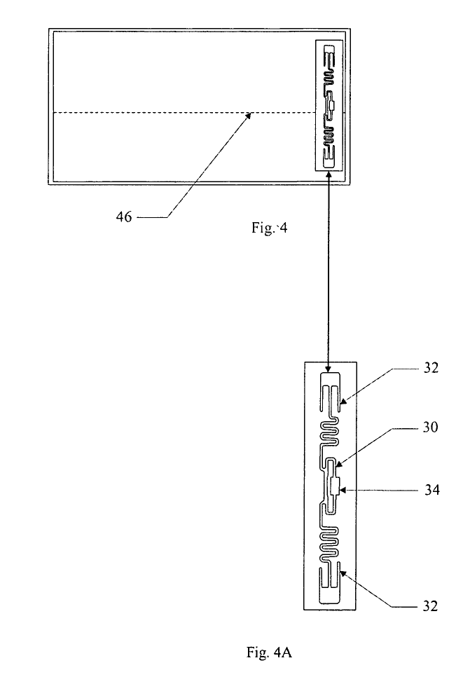

FIG. 4 shows a top view of a RFID label (12) of the invention, wherein the RFID tag (10) is shown embedded in a different position in the RFID label (12), now in the last fold, at the second end of the RFID label (12). FIG. 4a is a magnified top view of a RFID tag (10). The position of the RFID tag (10) is dependent on the number of folds to be made. The bottom coating of adhesive can cover the entire back surface of the layer of material (28) or could be along the last fold at each end of the RFID label (12), depending on the folding requirements.

The RFID label (12) of the invention after being encoded with data by the RFID printing/coding printers (44a/44b) further undergoes a folding process.

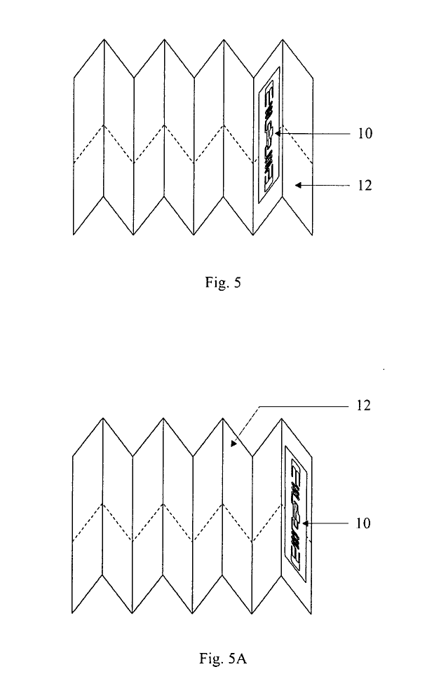

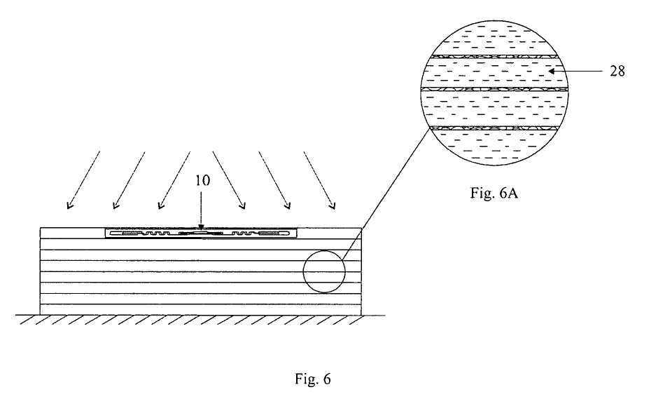

FIG. 5 is a perspective view of a RFID label (12) of the invention being enfolded lengthwise. The RFID label (12) is folded into a plurality of layers or folds along the entire length of the RFID label (12), beginning from the first end of the RFID label (12). The folding indicators are used to guide the folding device (42) in folding the RFID label (12) into a plurality of layers. The first fold formed at the first end of the RFID label (12) is folded to meet the adjacent fold and then compressed. The folded portion is then folded again to meet the adjacent fold until it reaches the final fold at the second end of the RFID label (12), where the RFID tag (10) is embedded. If the RFID tag (10) is not embedded at the final fold at the second end of the RFID label (12), the RFID label (12) is folded into a plurality of layers or folds, such that the RFID tag (10) is seen and exposed on the top of the folded (as in FIG. 6).

FIG. 5A is a perspective view of a RFID label (12) of the invention wherein the RFID tag (10) is located in a different position, said RFID label (12) being enfolded lengthwise. The RFID label (12) is folded into a plurality of layers or folds along the entire length of the RFID label (12), beginning from the first end of the RFID label (12).

FIG. 6 is a cross section view of a RFID label (12) of the invention, from second end, after completion of the folding process. A magnified cross section of the plurality of folds of layer of material (28) and layer of adhesive, which have been compressed, is shown at FIG. 6A. The magnified cross section shows the existence of air bubbles between the compressed layers of folded layer of adhesive and material (28). It can be seen that the folded RFID label (12) is a few folds high. The height of the folds of the RFID label (12) is called “stand off”. The inventors have found that the height of the folded RFID label (12) or “stand off” is also another factor to boost the readability of the RFID tag (10) when the folded RFID label (12) is affixed onto metallic or other surfaces of articles which interfere with RF waves.

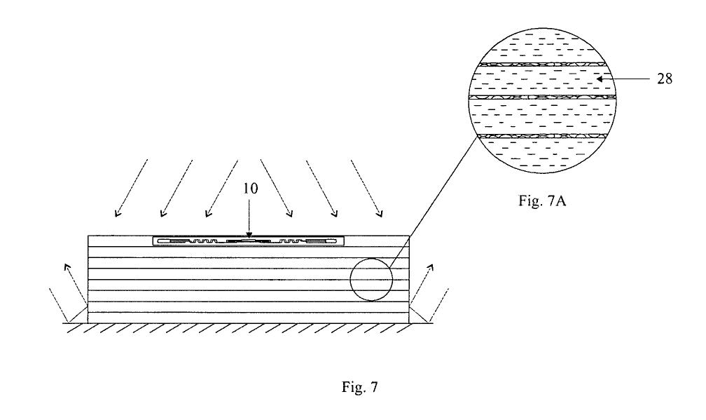

FIG. 7 is a cross section of a RFID label (12) of the invention, seen from the second end, affixed onto an article with a metallic or surface which interfere with RF waves. Transmission of signals from the transponder and reception of the signals by the RFID label (12) and surroundings are illustrated to show how the RFID label (12) of the invention allows radio frequency signals can be picked up by the RFID tag (10). The inventors have found that so long as the folded RFID label (12) has a standoff of more than one fold high on a surface which interferes with RF waves, the RFID tag (10) can be read. Therefore a RFID tag (10) in a RFID label (12) when folded into a plurality of folds, having a height equal to the number of folds forming the standoff, the RFID tag (10) in the folded RFID label (12) can be read by a RFID scanner (not shown) so long as the standoff has a height of two or more folds. The plurality of folds can range from at least two to more layers, the height of the standoff and number of folds dependent on read range and performance requirements.

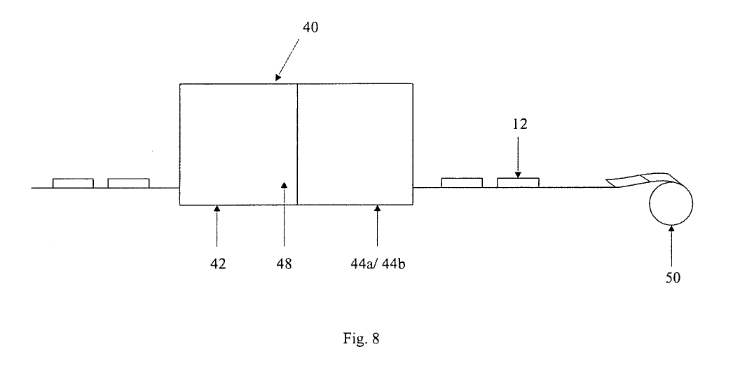

FIG. 8 is an illustration of an embodiment of a system for the encoding, printing and folding of RFID labels (12), to form the folded RFID label (12) having a standoff equal to the number of folds, which can be read on surfaces which interfere with RF waves. The RFID labels (12) are fed into printing/coding printers (44a/44b) and coded with data using coding software known in the art. After printing/encoding, the RFID labels (12) are then conveyed to the folding device (42). Since the RFID labels (12) have markings on it, the RFID labels (12) are aligned by the folding device (42) using sensors (not shown) to detect the sensor markings (36). The folding device (42) then folds the RFID label (12) into specified folds in accordance to the specific folding requirements. The RFID label (12) thus folded then undergoes compression, to force air trapped in between the folds of the RFID label (12) to escape. The folded RFID labels (12) are then conveyed out from the system.

A description of how the RFID label (12) of the invention is manufactured is given herein, for purpose of illustrating how the RFID label (12) is manufactured. A roll of RFID labels (12) are taken and mounted for feeding through a system for the encoding, printing and folding of RFID labels (12). The system includes RFID enabled printing/coding printers (44a/44b) which is known in the art. The inventive feature of the system is the folding device (42) which is integral in the system, hereinafter referred to as RFID encoding/printer/folding device (40).

If the RFID tags (10) are to be used for asset tracking, the appropriate electronic data to be encoded onto the RFID tags (10) are entered and printed/encoded onto the said RFID labels (12), using software known in the art. The RFID labels (12) can be of different sizes and dimensions, to fit the requirements of the user. The length and consequently number of folds will also determine the dimensions of the RFID labels (12) selected for the task.

Due to the different usage of the RFID tags (10), different types of material (28) are used to form the layer of material (28) for embedding the RFID tag (10). For instance, if the RFID tags (10) are used for asset tracking in the outdoors, suitable material for use as the layer of material (28) would include waterproof cloth, polyurethane or other suitable material (28).

Once the data for the RFID tags (10) have been entered into the RFID encoding/printing/folding device (40), a roll of RFID labels (12) selected for its suitability in use would be mounted onto a roller (not shown). The RFID data to be encoded would include data relating to the usage of the RFID tags (10), and include the number of folds required to be made for each RFID label (12) and folding sequence. The software for encoding RFID data is known in the art and would not be described herein.

The roll of RFID labels (12) are then mounted onto a feeder (50) to feed a continuous stream of RFID labels (12) into the RFID encoding/printing/folding device (40). The set up data to be encoded would also be entered into the RFID encoding/printing/folding device (40). The set up data including the usage of the RFID tags (10) number of RFID labels (12) in the run, position markings and the number of folds required to be made for each RFID label (12) would be entered separately into the RFID encoding/printing/folding device (40).

A trial run would commence for alignment of the RFID labels (12) using the sensors in the RFID encoding/printing/folding device (40) so that the printing would be in accordance with the specifications of the RFID labels (12).

After the set up and trial run is carried out satisfactorily, the RFID labels (12) are then conveyed into the RFID encoding/printing/folding device (40). The RFID labels (12) are firstly encoded with data. Once the RFID labels (12) have been appropriately encoded and bar code printed, the labels are then conveyed into the folding device (42) to be folded. The folding is carried out within the RFID encoding/printing/folding device (40). The folding device (42) receives as part of the earlier set up data input for printing and encoding, the number of folds and sequence of folding for the batch of RFID labels (12). The folding device (42) also has sensors (not shown) which detects the specified position marking on the RFID labels (12). Therefore after the printing/encoding, the folding device (42) will aligns the RFID labels (12) before carrying out the folding sequence to form the folded RFID labels (12) according to the number of folds required. The RFID encoding/printing/folding device (40) is most appropriately suited for large volumes of printing, encoding and subsequent folding of the RFID label (12). In this manner, the encoding, printing and folding of the RFID labels (12) are carried out in one single and continuous operation.

Alternatively, the encoding and printing can be carried out using a RFID encoding/printing device while the step of folding and compressing the RFID label is carried out manually.

The inventors have found out that the layer of material (28) on which the RFID tag (10) is embedded can be any non-metallic material, be it synthetic material such as cloth or fabric or paper or organic material such as cloth or paper, which have been treated with adhesive.

The inventors have found that so long there is a standoff of more than one fold high, the RFID tag (10) can be read when affixed onto metallic and other surfaces which interferes with RF waves. Therefore a RFID tag (10) in a RFID label (12) when thus folded into a plurality of folds, the said plurality of folds, being the height of the folds, forms a standoff. In such situations, the RFID tag (10) in the folded RFID label (12) can be read by a RFID scanner (not shown) so long as there is a plurality of folds in the standoff. The inventors have found that the plurality of folds can range from at least two to more layers, depending on read range and performance requirements. A RFID tag (10) formed by folding the RFID label (12) into a plurality of folds, which are then compressed to form the standoff, can be read even if affixed on surfaces which interfere with RF waves. As such, the inventive RFID tag (10) offers a low cost RFID solution to using RFID tags (10) on surfaces which interfere with RF waves, such as metallic surfaces, curved surfaces and reflective wrappings. The uses of such a RFID tag (10) formed from the invention are numerous such as asset tagging, anti-counterfeit device for cigarette packs, and expensive branded goods, and even valuable commodity items such as bags of rice.

Since the folded label can be affixed onto on curved surfaces, such as bottles and drums, the RFID labels (12) of appropriate dimensions can be mounted even on bottles of say, expensive liquor or perfume bottles.

When an anti-tampering perforation (46) is added to the RFID tag (10), and such a RFID tag (10) is affixed onto branded goods and branded consumable goods, the RFID tag (10) performs a valuable role in ensuring such goods cannot be mixed up with counterfeit goods as only genuine goods will be detected and verified easily and readily by a RFID scanner (not shown). Any attempt to remove the RFID tag (10) will inevitably cause forces of stress along the perforation running into the RFID antenna circuit, thus breaking the RFID antenna, rendering the RFID tag (10) unreadable. As mentioned, if the RFID tag (10) on an article cannot be read, its genuineness would be doubted.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings

### ADVANTAGEOUS EFFECTS OF THE INVENTION

A low cost RFID tag (10) which can be read even on surfaces causing interference of RF waves is suitable for many applications. A RFID tag (10) produced by a system of RFID encoding/printer/folding device (40) in one continuous process saves time and production costs too.

A low cost RFID tag (10) with an additional anti-tampering perforation (46) offers a low cost solution to the identification and tracking of small branded luxury goods such as cigarettes, wine bottles and even branded luxury bags and the like.

1. A RFID tag (10) for affixing onto surfaces which interfere with RF waves, said RFID tag (10) formed from a RFID label (12), said RFID label (12) comprising of a RFID tag (10) embedded in a layer of material (28), an upper adhesive layer (20) on the upper protective layer (24) and a lower adhesive layer (22) on the lower protective layer (26),
characterized in that the said RFID label (12) is encoded, printed and folded into two 10 or more folds which is then compressed to force out the air trapped between the folds to form a standoff of two or more folds high, and when the RFID tag (10) is affixed onto the surface which interfere with RF waves, said RFID tag can be read.

2. A RFID tag (10) for affixing onto surfaces which interfere with RF waves, said RFID tag (10) formed from a RFID label (12), said RFID label (12) comprising of a RFID tag (10) embedded in a layer of material (28), an upper adhesive layer (20) on the upper protective layer (24) and a lower adhesive layer (22) on the lower protective layer (26), characterized in that the said RFID label (12) is encoded, printed and an anti-tampering perforation (46) is made across the length of the RFID label (12) such that the anti-tampering perforation (46) runs right up to the RFID tag (10), said RFID label (12) further folded into two or more folds to form a standoff of two or more folds, and when the RFID tag (10) is affixed onto the surface which interferes with RF waves, said RFID tag can be read.

3. A RFID tag (10) as claimed in claim 1 to be affixed to surfaces which interfere with RF waves, such surfaces being metallic surfaces.

4. A RFID tag (10) as claimed in claim 1 to be affixed to surfaces which interfere with RF waves, such surfaces being curved surfaces.

5. A RFID tag (10) as claimed in claim 1 to be affixed to surfaces which interfere with RF waves, such surfaces being glass surfaces.

6. A RFID tag (10) as claimed in claim 1 to be affixed to surfaces which interfere with RF waves, such surfaces being bottles containing fluids.

7. A RFID tag (10) as claimed in claim 1 to be affixed to surfaces which interfere with RF waves, such surfaces being surfaces covered with reflective metallic foil.

8. A layer of material (28) for a RFID label (12) as claimed in claim 1, wherein the material (28) is made of plastic.

9. A layer of material (28) for a RFID label (12) as claimed in claim 1, wherein the material (28) is made of cloth.

10. A layer of material (28) for a RFID label (12) as claimed in claim 1, wherein the material (28) is made of paper.

11. A layer of material (28) for a RFID label (12) as claimed in claim 1, wherein the material (28) is a composition of laminates.

12. A RFID label (12) as claimed in claim 1 wherein the coating of adhesive on the bottom of the layer of material (28) is at both ends of the RFID label (12).

13. A RFID label (12) as claimed in claim 1 wherein the coating of adhesive on the bottom of the layer of material (28) is throughout, the bottom of the layer of material. (28)

14. A RFID label (12) as claimed in claim 1 wherein the RFID label (12) has markings indicated on it for alignment of the RFID label (12) and to aid in the folding process.

15. A method for making a RFID label (12) as claimed in claim 1, the method consisting of the following steps:
a. using a feeder (50) to feed a roll of RFID labels (12) into printing/coding printers (44a/44b) of data onto the RFID tag (10) in the RFID label (12);
b. encoding and printing data onto the RFID tag (10) and RFID label (12);
c. folding the RFID label (12) thus printed and encoded, into two or more folds to form a standoff; and
d. subjecting the folded RFID label (12) to compression forces, to force air trapped between the folds of the RFID label (12) to escape.

16. A system for encoding, printing and folding a RFID label (12) into a plurality of folds, to form a standoff which height is equal to the number of folds formed, the system comprising:—
a. a printing printer (44a) for printing data onto a RFID label (12) onto the RFID label (12);
b. a coding printer (44b) for encoding data onto the RFID tag embedded in a RFID label; and
c. a folding device (42) to fold the RFID label (12) lengthwise, in accordance to the number of folds required to form a standoff.

17. A system for encoding, printing and folding a RFID label (12) into a plurality of folds, to form a standoff which height is equal to the number of folds formed as claimed in claim 16, the system further comprising
a. a perforator (48) which makes a line of anti tampering perforations (46) along the length of the RFID label (12), right until the location of the RFID tag (10) embedded in the RFID label (12).

18. A system for encoding, printing and folding a RFID label (12) as claimed in claim 16, wherein the system has a plurality of sensors to detect the markings of the RFID label (12), in order to align the RFID label (12) and to fold the RFID label (12) in accordance with the number of folds required.

19. A method of making a RFID label (12) as claimed in claim 15, wherein the step of folding and compressing the RFID label is carried out manually.
